(19) United States
(12) Patent Application Publication
(10) Pub. No.: US 2026/0287342 A1
(43) Pub. Date: Sep. 24, 2026

(54) MEASURING DEVICE, MEASURING TABLE COMPRISING A MEASURING DEVICE, AND METHOD FOR MEASURING THE THICKNESS OF A FLAT COMPONENT, IN PARTICULAR A GAS DIFFUSION LAYER

(71) Applicant: Siemens Energy Global GmbH & Co. KG, München (DE)

(72) Inventors: Philip Terhorst, Essen (DE); Tim Schreiber, Witten (DE)

(21) Appl. No.: 19/476,728

(22) PCT Filed: Apr. 5, 2024
(86) PCT No.: PCT/EP2024/059283

§ 371 Date: Oct. 20, 2025

(30) Foreign Application Priority Data
Apr. 21, 2023 (DE) 102023203707.6

(51) Int. Cl. G01B 21/08; C25B 11/032; H01M 4/86

(52) U.S. Cl. CPC G01B 21/08; C25B 11/032; H01M 4/8605

(57) ABSTRACT

A method for determining the thickness of a gas diffusion layer for an electrochemical cell is provided. The electrochemical cell includes a lower pressure plate, an upper pressure plate, and a test weight which is guided via a vertical guide such that a specified testing force can be applied to a flat component to be tested via the gravitational force of the test weight during a measuring process so that a defined surface pressure is produced.

### BACKGROUND

The invention relates to a measuring device for measuring the thickness of a gas diffusion layer of an electrochemical cell, in particular a PEM electrolysis cell. The invention further relates to a measuring table comprising a measuring device and to a method for measuring the thickness of a gas diffusion layer.

Electrochemical cells are generally known and are subdivided into galvanic cells and electrolysis cells. An electrolysis cell is a device in which an electric current causes a chemical reaction, with at least some electrical energy being converted into chemical energy. A galvanic cell is a complementary device—to the electrolysis cell—for spontaneously converting chemical energy into electrical energy. A known device of such a galvanic cell is for example a fuel cell.

The splitting of water by an electric current for the production of hydrogen gas and oxygen gas by means of an electrolysis cell is well-known. A distinction is made in this case primarily between two technical systems, namely alkaline electrolysis and PEM (proton exchange membrane) electrolysis.

The core component of a technical electrolysis plant is the electrolysis cell, comprising two electrodes and an electrolyte. In a PEM electrolysis cell, the electrolyte consists of a proton-exchange membrane with an electrode on each side. The assembly of membrane and electrodes is referred to as MEA (membrane-electrode assembly). In the assembled state of an electrolysis stack made up of multiple electrolysis cells, the electrodes are contacted by what are referred to as bipolar plates via a gas diffusion layer, the bipolar plates separating the individual electrolysis cells of the stack from one another. In this case, the O₂ side of the electrolysis cell corresponds to the positive terminal and the H₂ side corresponds to the negative terminal, separated by the membrane-electrode assembly lying in between.

The PEM electrolysis cell is supplied on the O₂ side with fully desalinated water, which is broken down into oxygen gas and protons (H⁺) at the anode. The protons migrate through the electrolyte membrane and recombine at the cathode (H₂ side) to form hydrogen gas. The gas diffusion layer resting on the electrodes ensures, in addition to the contacting of the electrodes, optimum water distribution (and thus wetting of the membrane) and the removal of the product gases. An electrically conductive, porous element that readily stays in contact with the electrode in the long term is therefore required as gas diffusion layer. As an additional requirement, any dimensional tolerances that arise in the electrolyzer should be compensated for in order to allow for uniform contacting of the MEA in every instance of tolerance.

Sometimes, sintered metal disks have been used as the gas diffusion layer in known electrolysis cells. Although they meet the requirements in respect of electrical conductivity and porosity, an additional tolerance compensation of the components of the electrolysis cell on both sides of the gas diffusion layer is not possible. Moreover, the manufacturing costs for such disks are comparatively very high and there is a restriction on their size owing to the pressing forces required during the manufacture of such disks. In addition, large components give rise to problems relating to warping which can only be controlled with difficulty.

The use of gas diffusion electrodes with resilient elements for establishing electrical contact in the case of alkaline electrolyzers is described for example in WO 2007/080193 A2 and EP 2436804 A1.

EP 1378589 B1 discloses a spring sheet, in which the individual spring elements are bent alternately upward and downward. The spring sheet is incorporated in an ion exchange electrolyzer only on the cathode side, such that the spring sheet contacts the cathodes directly.

US 2003/188966 A1 describes a further spring component for an electrolysis cell, which is located between a partition wall and a cathode. The spring component comprises a multiplicity of leaf spring elements, which rest on the cathode for uniform adjustment. Further gas diffusion electrodes of different structures are described in WO 2002035620 A2, DE 10027339 A1 and DE 102004023161 A1.

EP 2 957 659 B1 discloses a gas diffusion layer to be fitted between a bipolar plate and an electrode of an electrochemical cell. The gas diffusion layer comprises at least two layers stacked one on top of another, one of the layers being in the form of a spring component having a progressive spring characteristic curve. A progressive spring behavior ensures that the contact pressure is sufficient in all tolerance positions of the contiguous components. The implementation of a progressive spring behavior in a gas diffusion layer is achieved in this respect by the geometry of the spring component. This makes it possible to compensate for component tolerances that arise, at least within certain limits, in an electrochemical cell, in particular in an electrolysis cell or galvanic cell, in particular in the region of the bipolar plates.

WO 2021/018459 A1 describes an electrolysis cell comprising a cell frame and a method for producing an electrolysis cell. The cell frame has a stepped inner profile. The inner profile comprises at least one support surface for receiving a planar component in the cell frame. The support surface has a recess for a seal. Owing to the stepped inner profile, the first gas diffusion layer projects beyond the boundaries of the second gas diffusion layer. The size of the gap between the cell frame and the membranes, i.e. gas diffusion layers, can therefore advantageously be larger. This advantageously makes the assembly process easier and shorter. Furthermore, the outer contours of the membranes and/or gas diffusion layers can advantageously be selected with a great degree of freedom.

### SUMMARY

A typical structure of a PEM electrolysis cell comprises a first gas diffusion layer and a second gas diffusion layer. The proton exchange membrane is located between the gas diffusion layers. All of the layers are arranged in a cell frame. The gas diffusion layers must be arranged in the cell frame with high precision in order to produce a reliably functioning electrolysis cell and subsequently a multiplicity of electrolysis cells formed into a stack. This generally makes the production of the components and the assembly very complex.

In particular, in the case of a multiplicity of electrolysis cells stacked one behind another to form a stack, the manufacturing-related deviations caused by variations in the thickness of the gas diffusion layers of electrolysis cells by a thickness tolerance that is still permissible in individual cases can add up and lead to impermissible mechanical stresses when the cells are being braced to form a stack having a multiplicity of electrolysis cells.

There is therefore an increasing need in the manufacture of gas diffusion sub-layers for electrolysis cells to improve the measurement accuracy and the reproducibility of the thickness measurement in terms of an envisaged industrial series production. The quality assurance in manufacture at electrolysis cell level is becoming increasingly important here, in order to provide large numbers of commercially available electrolyzers with considerable electrolysis output.

Against this background, the invention is based on the object of specifying an improved measuring device in terms of measurement accuracy and reproducibility. A further object of the invention to specify a method for measuring the thicknesses of stacked gas diffusion sub-layers, distinguished by high precision and reproducibility.

The object is achieved according to the invention by a measuring device for measuring the thickness of a gas diffusion layer for an electrochemical cell, comprising a lower pressure plate and an upper pressure plate and a test weight guided via a vertical guide in such a way that, during a measuring operation, a predefinable testing force can be applied via the force of the weight of the test weight to a sheet-like component that is to be tested, so that a defined surface pressure is exerted, and further comprising a distance sensor which makes it possible to determine, as measured thickness value, the distance taken up by the sheet-like component between the upper pressure plate and the lower pressure plate under the predefinable testing force.

The invention is based in this respect already on the finding that gas diffusion sub-layers of electrolysis cells have particularly high requirements for the respective height, i.e. thickness, profile. Dimensional accuracy and dimensional stability are becoming increasingly important, in particular for large-format gas diffusion sub-layers, as are currently being developed and projected for use in high-output electrolyzers. In the fitted state, gas diffusion sub-layers are pressed together and must, under pressure, accurately fittingly fill a predetermined structural space in the electrolysis cell. The gas diffusion sub-layers have spring-like force/travel characteristic curves generally within certain limits. Since in the use case a multiplicity of electrolysis cells are interconnected one after another and formed into a stack, the thickness tolerances add up cumulatively. The invention has identified that conventional measuring devices and available universal testing machines are not sufficient in this case to be able to as accurately as possible measure the thicknesses of the splayed and sheet-like gas diffusion sub-layers with a required measuring uncertainty of <0.01 mm. With regard to increased requirements for measurement accuracy, dimensional stability and reproducibility, it is thus possible to observe a high demand for a measuring device and a measuring method for at the same time enabling application to and as straightforward as possible integration in an industrial manufacturing process for electrolysis cells combined with a still-reasonable outlay for the required quality assurance.

Up to now, conventional universal testing machines have been used to ascertain thickness. They are equipped with pressure plates and used in the “pressure test” mode, in which the testing force is adjusted via usually electric drives and a drive spindle. The problem is that these machines deform under an applied compressive force, this giving rise to a distortion of the measurement result, specifically sometimes 1-2 orders of magnitude above, i.e. outside of, the required measurement accuracy. It is routine to very laboriously compensate for the measured values by means of one-off recorded compensation curves, but this compensation has to be checked and corrected regularly. In the event of changes, the measurement result cannot be used directly. If the machine exceeds the force range, the affected component can be irreparably damaged, for example pressed too thin beyond the minimum thickness. In addition to the time required for constant checking—specifically after each component—and regular correction, typically between 2 and 10 times per layer, the manufacture considerably depends on external influences such as humidity fluctuations, temperature fluctuations, etc. This measurement principle and the associated disadvantages are the same for all universal testing machines under consideration. In addition, in the standard structure some of the testing force is used to align curved sheet-like components flat on the table, this being very disadvantageous.

The measuring device of the invention overcomes these disadvantages, meeting high accuracy requirements for the measuring device for quality assurance on an industrial scale. The measuring device makes it possible to ascertain for example the thickness of a resilient gas diffusion sub-layer—in the form of a sheet-like component—made of an expanded metal under a well-defined testing force. The measuring device designed in this way can advantageously be operated on an industrial scale in a production hall in 3-layer operation. The measuring device is set up in such a way that, during a measuring operation, the testing force is introduced into the sheet-like component solely via the predefined force of the weight of the test weight. This makes it possible to obtain a defined surface pressure in the region of the upper pressure plate and of the lower pressure plate and thus an undistorted measurement result for the measured thickness value, which can be precisely ascertained by the distance sensor as the distance between the pressure plates. The vertical guide allows a guided vertical lowering and lifting of the test weight and, during a measuring operation, planar support of the upper pressure plate and exertion of compressive force by the upper pressure plate on the sheet-like component that is to be measured.

The measuring device is especially advantageously applicable to, and especially advantageously designed for, determining the thickness of expanded-metal-based gas diffusion layers or gas diffusion sub-layers in the form of sheet-like components that are to be measured. In series operation of the measuring device, large-area sheet-like components with preferably rectangular base areas of different sizes can be measured precisely and reproducibly with a high cycle rate. The sheet-like components-such as gas diffusion sub-layers can thus be subjected to profile cutting in the industrial manufacturing process and, both before and after the cutting, be measured with the measuring device at identical points and undergo quality assurance. The measuring device is advantageously applicable preferably to measuring the thickness of sheet-like components with, for example, a length of 600-1500 mm, a width of 350-450 mm and a height of 0-7 mm. The height of the sheet-like component corresponds to the measured thickness value to be determined, which can be determined with a high degree of accuracy.

In one embodiment, e the measuring device comprises a lifting mechanism by means of which the test weight can be lowered and as a result the predefinable testing force can be applied to the sheet-like component via the force of the weight.

The predefined testing force can be introduced particularly easily into the sheet-like component solely via the force of the weight of the test weight, specifically locally via the contact surface of the upper pressure plate. As a result, the stiffness of the measuring device and a superordinate machine structure incorporating the measuring device do not influence the measurement accuracy. In addition, a test weight is an energy source which scatters only to a very limited extent and virtually does not vary over time. The lifting device can be used to lower the test weight for the measuring operation and to bring about the predefined surface pressure.

In a one embodiment of the measuring device, the lifting mechanism is configured such that, during a measuring operation, the test weight undergoes a decoupling, with the result that no additional force is applied to the sheet-like component beyond the testing force imparted by the test weight.

Consequently, by lowering the test weight, the testing force is introduced into an inserted sheet-like component only locally in the region of the defined contact surfaces of the upper pressure plate and of the lower pressure plate. The distance between the upper pressure plate and the lower pressure plate can then be measured by the distance sensor under well-defined test conditions. In the case of sheet-like components in the form of gas diffusion sub-layers, a surface pressure of typically for example 0.6 N/mm² with a testing force of about 1180 N is advantageous. The thickness, i.e. height, of the sheet-like components is defined as the distance between the upper and lower pressure plates when they lie flat against the component and are subjected to the testing force.

During a complete measuring procedure using the measuring device, the force of the weight must be taken away from the sheet-like component in order to safely insert and remove the sheet-like component. For this, the test weight can advantageously be lifted by the lifting mechanism, so that for example a clearance of approximately 40 mm is formed between the sheet-like component and the upper pressure plate. The weight is lifted and lowered gently, in order to not damage the sheet-like component that is to be tested. For this purpose, in the measuring device the lifting mechanism is designed to be controlled and guided in such a way that the acceleration and speed of the test weight are limited. The limit can be set, for example by setting a limiting valve that is to be provided, for example in the case of a pneumatic or hydraulic damping and limiting unit for lifting and lowering.

The lifting mechanism is designed in such a way that, in the actual measuring phase, only the force of the weight exerted by the test weight bears on the sheet-like component. In this phase, the lifting mechanism itself is completely decoupled and does not introduce any additional force of weight, and therefore the measurement result is not distorted. For example, a lifting mechanism based on a cable guide with corresponding rollers and drive units for lifting and lowering the test weight are conceivable.

In the case of the measuring device, the force of the weight of the test weight can be set, making it possible to calibrate the testing force.

The material and the volume of the test weight are selected in such a way that the resulting force of the weight of the structure, including pressure plates etc., resting on the sheet-like component corresponds to the required test force. Depending on the specific requirement, the predefined testing force can be ascertained and set, for example by means of a balance. To this end, the test weight may be composed of a multiplicity of weight units.

As a result, an adjustment and calibration option can advantageously be implemented, in order to finely set and, as and when required, vary the testing force for example by selectively adding/removing weight units.

With preference, a possible way of varying the testing force in the range from 950 (surface pressure 0.5 N/mm² ) to 2000 N (surface pressure 1 N/mm²) is therefore implemented in the measuring device, for example by way of corresponding reserves of space for a change in the test weight. For industrial manufacture and quality control, this provides flexibility of the measuring device with regard to an option for generous adjustment of the testing force by a preferred value of for example 1178±10 N.

In one embodiment of the measuring device, the vertical guide is prevented from rotating about the vertical axis, thereby ensuring a positionally accurate and reproducible lowering of the test weight.

Via the vertical guide, the test weight can be precisely guided linearly upward and downward at the same time and is prevented from rotating about the axis of movement, and therefore in mechanical terms a linear guide is implemented in the measuring device under a constraint. The vertical guide is thus advantageously in the form of a vertically aligned longitudinal guide which is as low-friction as possible, in order to be able to conduct the force of the weight of the test weight as unchanged as possible onto the sheet-like component that is to be tested. It is possible to use for example brass bushings in which a rod or vertically aligned metal shaft is guided.

In one embodiment, in the measuring device provision is made of a calibration device for ascertaining a current reference value as the zero point of the distance measurement and thereby calibrating the distance between the upper pressure plate and the lower pressure plate.

As a result, a calibration of the zero point of a distance measurement between the upper and lower pressure plates is provided between the measuring operations as and when required, routinely or regularly. The distance sensor is thus provided with a calibration function, the effect of which is a precise measurement of the thickness. The distance taken up by, and thus the thickness of, the sheet-like component which has been introduced into the measuring device therefore results from a length measurement. To this end, it is possible to provide an automated length measuring unit comprising the distance sensor with the calibration function. The advantageous main functions of the length measuring unit emerge from the fact that it is possible to ascertain the position of the weight of the test weight relative to a positionally fixed, i.e. stationary, point, for instance on the housing of the measuring device. The introduction of force of the test weight makes it possible to separate and thus decouple the force path of the measurement from the force path of the lifting mechanism, in order to achieve the best possible measurement results.

In order to obtain an exact distance between the upper pressure plate and the lower pressure plate in every measurement, the measuring device firstly needs to be referenced, i.e. “zeroed”, without an inserted component that is to be tested. With preference, during operation of the measuring device, this reference is regularly checked, ideally always between two components. During a zero measurement, the pressure plates are moved up to one another face-to-face without a component and the measured value output is identified as the “zero value” of the tool distance. If the magnitude of the measured value is greater than a permissible maximum value, for example >3 μm, the reference is automatically reset and the measuring device is calibrated accordingly. This procedure allows drift over time, for example caused by changes in temperature, to be detected and compensated for in situ during operation of the measuring device. This zero-point calibration is automated by a control and regulation unit advantageously integrated in the measuring device. The control and regulation unit can also implement further functions of the automation of the measuring process.

In one embodiment of the measuring device, provision is made of a dead weight arranged radially on the outside of the vertically guided upper pressure plate so that, when the upper pressure plate is being lowered, a sheet-like component that is to be tested can be pressed flat onto the support under the force of the weight of the dead weight.

The dead weight is an additional weight and ensures that the sheet-like component rests flatly on the planar support. The arrangement of the dead weight radially on the outside of the pressure plates causes the dead weight to be completely decoupled from the measuring operation and to not take part in the measurement or influence the surface pressure under the predefined test weight. The dead weight is advantageously used solely to position and flatly rest the sheet-like component on the planar measuring support, in particular at the edges thereof.

Since the sheet-like components often have a slight manufacturing-related curvature which can influence the measurement result, in one embodiment a circular dead weight, or a dead weight in the form of a circular ring, is integrated radially around the upper pressure plate in the measuring device. This means that the sheet-like component, in particular a gas diffusion sub-layer made of an expanded metal, can be pressed flat onto the support and also positioned irrespective of the testing force. The force of the weight of the additional weight is not included in the testing force, this being realized by the fact that the additional weight is seated outside of the plane-parallel measuring surfaces of the upper and lower pressure plates at a predefined distance. The dead weight preferably rests at least 15 mm away from the measuring surfaces.

With preference, in the case of the measuring device, the dead weight is prevented from rotating about the vertical axis, and the dead weight can be arrested and detached as and when required.

This also provides access to the upper pressure plate and further functional parts of the measuring device, for example in the event of service. The dead weight is secured against rotation about the vertical axis and can be arrested and detached in a vertically upper point of the measuring device. The arresting in the upper point is required in order to adjust the ball coupling, clean the pressure plates and perform measurements without the dead weight.

The counter surface of the additional weight or dead weight on the support for the sheet-like component is preferably also in the form of a circular ring with the same dimensions as the dead weight itself. The support surface for the component, including the lower pressure plate, is preferably slightly raised from the support, for example a table surface in the form of a granite plate. To make it easier to place the sheet-like components that are to be measured into a measuring position, the support surfaces are designed with bevels or chamfers with an angle of for example 20°. The following parameters have proven to be advantageous for the dead weight: The inside diameter of the additional weight ring is 110 mm, the outside diameter of the additional weight ring is 140 mm, and the dead weight has a mass of 15 kg. Depending on the measurement task and size of the sheet-like component, adjusted diameters can also be applied. The contact surfaces of the additional weight with the sheet-like component that is to be measured are preferably made of hardened and corrosion-resistant stainless steel, it being possible to use for example 1.4923 or 1.4021 steels.

In one embodiment of the measuring device, the pressure plates are both designed as planar circular plates, which are made of a hardened stainless steel and are aligned congruently and in plane-parallel fashion relative to one another.

The upper pressure plate is preferably connected to a shaft of the test weight via a ball joint, with the result that a plane-parallel alignment of the pressing surfaces of the upper pressure plate and of the lower pressure plate can be set.

For example, both the movable upper pressure plate and the lower pressure plate, which is fixedly integrated in the support, are in the form of circular plates made of corrosion-resistant hardened steel, for example 1.4923 or 1.4021 steel. The diameters of the circles should advantageously be machined to 50+/−0.05 mm, the component contact surfaces being ground (Rz<4) in order to achieve the best possible plane parallelism of the contact surfaces. A larger chamfer of >0.1×45° should be avoided in order to not distort the surface pressure, so that precisely predefined circular, congruent and plane-parallel standard surfaces are provided by the pressure plates.

In order to precisely align the pressure surfaces of the upper and lower pressure plates parallel to one another, the upper pressure plate is advantageously connected to the shaft of the test weight via a ball coupling. During the calibration, the ball coupling is fixed in place and positioned under the measuring pressure. The ball coupling is designed in such a way that rotational movement about the vertical axis is possible and the ball center point is advantageously located on the contact surface of the upper pressure plate. In order to reach the fixing unit of the ball joint under measuring pressure, the dead weight is fixed in place at its upper position.

With preference, the measuring device has a plurality of plate pairs each comprising an upper pressure plate and a lower pressure plate, the plate pairs being arranged such that, during a measurement, the thickness of a sheet-like component introduced for a measurement can be ascertained at multiple measurement points simultaneously.

In this way, the thickness of a sheet-like component can be measured at multiple different points at the same time. This allows a particularly uniform surface pressure and setting of the thickness for splayed sheet-like components, such as gas diffusion sub-layers made of expanded-metal sheets stacked one on top of another. The thickness of the components can be measured for example at 6 points at the same time. The measuring device is particularly advantageously designed and set to provide a surface pressure of e.g. 0.6 N/mm² between circular pressure plates each with a diameter of 50 mm and a test weight of 1178 N +/−10 N in the form of one exemplary embodiment. The distances between the measurement points are preferably constant; the distances from the edge of the sheet-like component can differ depending on the component. To this end, adjustable stops for positioning the sheet-like component may be provided in the measuring device.

The thickness, i.e. height, of the components is defined as the distance between the upper and lower pressure plates when they lie flat against the sheet-like component and are subjected to the predefined testing force.

In the case of the measuring device, therefore, preferably the plate pairs of the upper pressure plate and lower pressure plate are arranged uniformly over the surface, so that respective local measured thickness values for a sheet-like component introduced for a measurement can be determined. A uniform grid-like arrangement and positioning of the plate pairs in the form of rectangular or square grids with regard to the sheet-like component surface is particularly advantageous for a locally measuring the thickness at a multiplicity of measurement points. Since the sheet-like components have a highly reproducible behavior under compression with a spring constant of up to 50 kN/mm, a uniform positioning of the measurement points on the sheet-like component is preferred. This is particularly true for gas diffusion sub-layers made of expanded metal, as are used for electrolysis cells.

The object is further achieved according to the invention by a measuring table comprising a measuring device and comprising a tabletop in which a lower pressure plate is integrated, with a support surface for receiving a sheet-like component of which the thickness is to be measured being formed on the tabletop. The measuring table comprising the tabletop is designed such that, during the measuring operation, the sheet-like component rests only on the contact surface of the dead weight and the lower pressure plate, which is raised in relation to the table surface. The tabletop at the same time provides good guidance and reproducible positioning of the sheet-like components, in particular when they are being inserted and removed during the measuring operation.

In one embodiment, the measuring table comprises a control unit which has a control panel, so that the measuring process can be controlled and monitored, and measured data from the distance sensor can be read into a processor and processed.

To control and monitor the process, a computer which has an operating unit comprising a control panel is preferably provided. At the operating station, the measurement results can also be indicated visually for an operator, for example via a monitor or a display. A measurement can be initiated by the operator, for example via a foot switch. A service function with an optional manual mode is advantageously implemented in the control unit. The operator comes up to the lower end position of the test weights in order to be able to adjust for example the ball coupling and in order at the same time to secure the test weights.

The measuring table preferably comprises a transporting unit for loading and unloading a sheet-like component.

Implementing an automated feed of the sheet-like components is particularly advantageous in this case.

The object is also achieved by a method for measuring the thickness of a gas diffusion layer of an electrochemical cell, wherein a measuring device is provided, and in which method: a gas diffusion layer is inserted into the measuring device in the form of a sheet-like component; during a measuring operation, a predefinable testing force is applied to the gas diffusion layer via the force of the weight of the test weight by lowering the test weight so that a defined surface pressure is exerted; and the distance between the upper pressure plate and the lower pressure plate under the predefinable testing force is determined.

In the method, with preference a current reference value is ascertained as the respective zero point and thereby the distance between the upper pressure plate and the lower pressure plate is calibrated.

The repeatability and precision of the thickness measurement is crucial and is preferably set to values of <5 μm. The measuring device is also comparable with existing measuring systems. In order to check the repeatability, the method involves performing a “zero measurement run” without a component in order to reference the measuring system.

Furthermore, during the method, the thickness is preferably measured simultaneously at multiple measurement points distributed over the surface of the gas diffusion layer.

The measurement points can be uniformly distributed in the form of a grid over the surface of the gas diffusion sub-layer. Only the plane-parallel and congruent surfaces of the upper and lower pressure plates at the respective measurement points act as an effective functional surface for the introduction of force by the predefined test weight.

The advantages of the measuring method according to the invention emerge correspondingly from the advantages of the measuring device.

Further advantages, features and details of the invention will become apparent from the following description of preferred working examples and also on the basis of the drawing. The features and combinations of features mentioned above in the description and also the features and combinations of features mentioned below in the description of the figures and/or shown on their own in the individual figures can be used not only in the respectively specified combination, but also in other combinations or on their own without departing from the scope of the invention.

### BRIEF DESCRIPTION OF THE DRAWINGS

Working examples of the invention are elucidated in detail by a drawing. In the drawing, in schematic and highly simplified form:

FIG. 1 shows the basic structure of an electrochemical cell which by way of example is in the form of a PEM electrolysis cell;

FIG. 2 shows a simplified representation of the basic measurement principle of the invention for determining the thickness of a sheet-like component in the form of a gas diffusion layer;

FIG. 3 shows an arrangement of multiple measurement points on a gas diffusion layer;

FIG. 4 shows a view of a measuring device for a selected measurement point of a gas diffusion layer;

FIG. 5 shows a view of a measuring device before the measurement, with an inserted gas diffusion layer;

FIG. 6 shows the measurement device according to FIG. 5 during the measurement;

FIG. 7 shows a sectional view of a lower punch with a lower pressure plate;

FIG. 8 shows a plan view of the lower punch according to FIG. 7;

FIG. 9 shows a schematic plan view of a measuring table which has the measuring device and an inserted gas diffusion layer.

### DETAILED DESCRIPTION

FIG. 1 schematically shows the structure of an electrochemical cell 31 in the form of a PEM electrolysis cell. The electrochemical cell 31 is part of an electrolyzer, which is not shown in more detail here, for splitting of water by an electric current for the production of hydrogen and oxygen.

The electrochemical cell 31 comprises an electrolyte made up of a proton-exchange membrane 33 (PEM) with an electrode 35a, 35b on each side. The assembly of membrane and electrodes is referred to as a membrane-electrode assembly (MEA). The electrode 35b denotes a cathode, and the electrode 35a denotes an anode. A gas diffusion layer 11 rests on each of the electrodes 35a, 35b. The gas diffusion layers 11 are contacted by what are referred to as bipolar plates 37, which in the assembled state of an electrolysis stack made up of multiple individual electrolysis cells 31 separate the electrolysis cells from one another.

The electrochemical cell 31 is supplied with water, which is broken down into oxygen gas O₂ and protons H⁺ at the anode 35a. The protons H⁺ migrate through the electrolyte membrane 33 in the direction of the cathode 35b. On the cathode side, they recombine into hydrogen gas H₂.

In another working example, the electrochemical cell 31 is in the form of a galvanic cell or fuel cell designed to generate power. According to the invention, the gas diffusion layers 11 of electrochemical cells 31 designed in this way are intended to be modified similarly to the electrolysis cell 31 represented in FIG. 1. Without restricting the generality, the following text therefore makes reference by way of example to an electrochemical cell 31 in the form of an electrolysis cell.

The gas diffusion layer 11—also referred to as gas diffusion sub-layer—is a sheet-like component 10 and a functional layer which is important for the electrolysis cell 31 and has various tasks during operation of an electrolysis cell 31. The gas diffusion layer 11 ensures optimal distribution of the water and the removal of the product gases. In the case of a galvanic cell, the gas diffusion layers 11 correspondingly serve to supply reactants to the respective electrodes. It is essential in this case that the gas diffusion layer 11 is in any case sufficiently permeable to the gaseous products and/or reactants, so that they can be removed.

The gas diffusion layer 8 also serves as a current distributor, in particular in the case of an electrolysis cell. That is why the gas diffusion layer 8 is made of an electrically conductive, porous material.

In the working example shown, the gas diffusion layer 11 compensates for component tolerances, in particular those of the bipolar plates 37 resting thereon. The gas diffusion layer 11 therefore contains sub-layers stacked one on top of another, an outer sub-layer being in the form of a spring component which has a progressive spring characteristic curve. The gas diffusion layer 11 in particular comprises a contacting component, a diffusion component and the spring component, which specifically differ from one another in terms of their structure and/or composition.

The gas diffusion layer 11 of electrolysis cells 37 comprising multiple layered diffusion sub-layers must meet particularly high requirements for the respective height profile, i.e. thickness profile, and owing to the predefined structural space of the cell frame, be designed and manufactured in accurately fitting fashion for use in an electrolysis cell 37. Dimensional accuracy and dimensional stability with regard to the permissible thickness are becoming increasingly important, in particular for large-format gas diffusion sub-layers 11, as are currently being developed and projected for use in high-output electrolyzers. Therefore, quality assurance in the setting of the thickness of the gas diffusion layer 11 is very important for an industrial manufacturing process with high numbers of items and large effective functional surfaces. In addition, the permissible thickness tolerances must be monitored during the axial stacking and mechanical bracing of a multiplicity of electrolysis cells 31 to form a high-output electrolyzer.

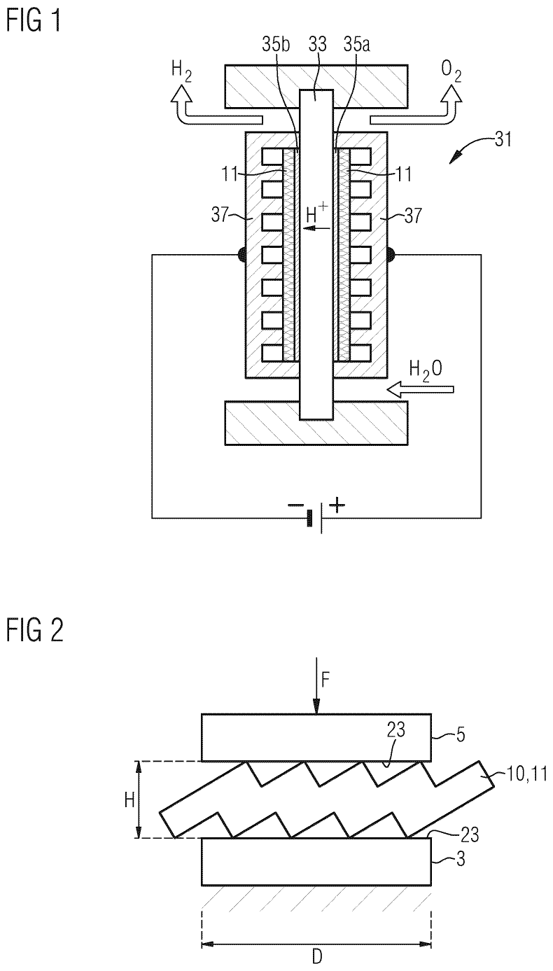

FIG. 2 schematically represents the measurement principle, in order to show the thickness measurement on a pre-fabricated, multi-layered gas diffusion layer 11. The gas diffusion layer 11 contains sub-layers-not represented in more detail-stacked one on top of another, an outer sub-layer being in the form of a spring component which has a progressive spring characteristic curve. The gas diffusion layer 11 comprises in particular a contacting component for the supply of electrical power, a diffusion component for media transport and a spring component for the required elastic properties on installation of the gas diffusion layer 11 in a cell frame. The components and sub-layers of a gas diffusion layer can differ from one another in terms of their structure and/or composition corresponding to the function and installation situation. A circular upper pressure plate 5 and a corresponding congruent circular lower pressure plate 3 with the same diameter D are arranged vertically one on top of the other, thereby forming an intermediate space. A gas diffusion layer 11 which comprises multiple gas diffusion sub-layers and of which the thickness is to be determined has been inserted into the intermediate space. The upper pressure plate 5 is vertically movably guided such that it can be lowered and lifted, while the lower pressure plate 3 is fixedly integrated in a solid support. The upper pressure plate 5 and the lower pressure plate 3 have flat plane-parallel component contact surfaces 23 with the same precise diameter of for example D=50±0.05 mm, in order to exert a predefined and well-defined surface pressure under the application of a vertical testing force F during a measuring operation. The pressure plates 3, 5 consist of hardened and corrosion-resistant steel, such as 1.4923 or 1.4021. The component contact surfaces 23 are ground in order to obtain the best possible plane parallelism.

Applying the testing force F to the upper pressure plate 5 results in a defined surface pressure of for example 0.6 N/mm² at the selected measurement point of the gas diffusion layer 11. This defined pressing of the surface has the effect that the measured thickness value H that is to be determined is obtained for the gas diffusion layer 11, the measured thickness value H being defined as the distance between the upper pressure plate 5 and the lower pressure plate 3. The measuring arrangement ensures that the upper pressure plate 5 and the lower pressure plate 3 rest flatly on the gas diffusion layer 11 by way of the component contact surface 23 and are subjected to the testing force F. The testing force F is set to a fixed value of for example F=1178±10 N.

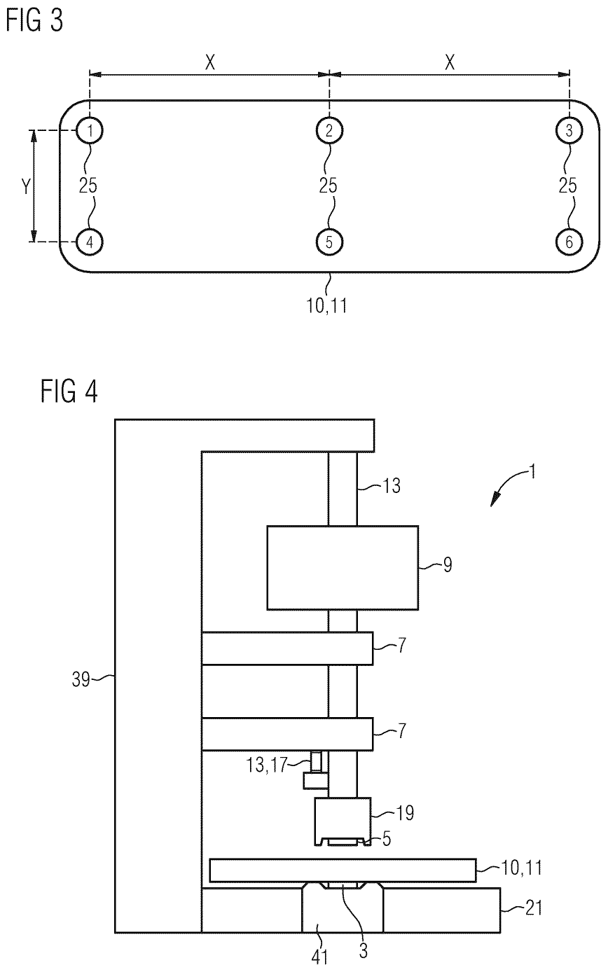

FIG. 3 shows a view—in the present case a top view—of a sheet-like component 10 using the example of a sheet-like rectangular gas diffusion layer 11. Multiple measurement points 25 uniformly distributed on the sheet-like component 10 are predefined. Each of the measurement points 25 is formed by a circular surface region corresponding to the component contact surfaces 23 of an upper pressure plate 5 and of a lower pressure plate 3 according to FIG. 2. The measurement points 25 are arranged in the form of a grid with a predefined grid distance X and Y with respect to the component axes of the sheet-like component 10 in the direction of its longitudinal extent, i.e. along the x-axis, and its width extent, i.e. along the y-axis. In the present case, six measurement points 25 are predefined, so that the height of the component can be locally determined at six measurement points 25 at the same time in each case under application of the same surface pressure per measurement point 25 of for example 0.6N/mm². In the view according to FIG. 3, the height of the component is defined perpendicularly in relation to the plane of the sheet-like component 10 that is defined by the x-axis and the y-axis. Typically, the rectangular grid of measurement points can be designed with constant distances, with X=635 mm and Y=210 mm. The distances between the measurement points 25 and the edge of the component can differ depending on the sheet-like component 10 and can be adapted as and when required. The gas diffusion layer 11 in the form of a sheet-like component 10 has particularly readily reproducible behavior under compression. The spring constants of the gas diffusion layer 11 are up to 50 kN/m.

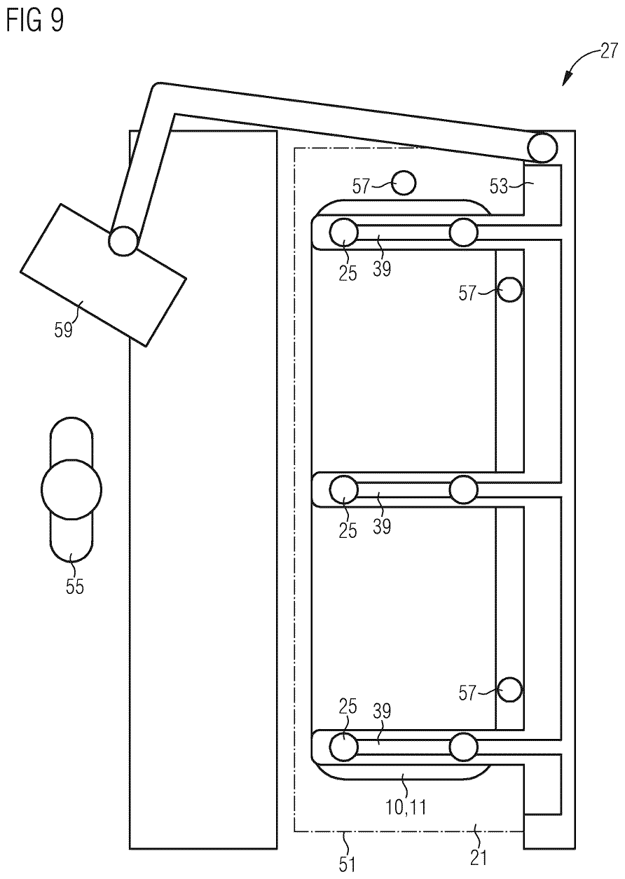

FIG. 4 shows a view of a measuring device 1 for a selected measurement point 25 of a gas diffusion layer 11. The measuring device 1 is designed to precisely measure the thickness of a gas diffusion layer 11. The measuring device 1 has a lower pressure plate 3 and an upper pressure plate 5 and also a test weight 9. The test weight 9 is guided vertically movably and with low friction and is prevented from rotating about the vertical axis via a vertical guide 7. The lower pressure plate 3 is embedded and fixed in place in a solid tabletop 21, for example made of granite. In this case, the lower pressure plate 3 is separate and raised but in the form of an integral constituent part of a fully metallic lower punch 41 embedded in the tabletop 21. The upper pressure plate 5 is mechanically coupled to the test weight 9. A predefined force of weight can thus be introduced via the test weight 9 into the upper pressure plate 5 and a sheet-like component 10 that is to be tested can be subjected to a defined surface pressure. To this end, the measuring device 1 has a lifting mechanism 15 which can be used to lower the test weight 9 with vertical guidance, as a result of which the predefined testing force F (see FIG. 2) can be applied to the sheet-like component 10 alone via the force of the weight of the test weight 9. The lifting mechanism 15 is configured such that, during a measuring operation, the test weight 9 undergoes a complete decoupling, with the result that no additional distorting force is applied to the sheet-like component 10 beyond the testing force F imparted by the test weight 9. This makes it possible to very precisely and reproducibly measure the thickness of a gas diffusion layer 11 that is to be tested by the measuring device 1. A cantilever arm 39 in the form of a C-profile takes up, via the lifting mechanism 15, the force exerted by the test weight 9. The cantilever arm 39 is particularly stable and solid. Further, the cantilever arm 39 is also used to fasten a guide unit 53—shown in more detail in FIG. 9—of the lifting mechanism 15, for example based on a cable pull system, for the lifting and lowering of the test weight 9 during a measurement cycle. To ascertain an accurate measured thickness value H for the thickness of the gas diffusion layer 11 under the test conditions and surface pressure specified, a distance sensor 13 integrated in a superordinate measuring and calibration unit 17 is provided. This makes it possible to determine and continuously check a current reference value as the zero point of the distance measurement, and as a result the distance between the upper pressure plate 5 and the lower pressure plate 3 can be regularly recalibrated as and when required. In addition, a dead weight 19 is provided as an additional weight in the measuring device 1 for the purpose of stabilization and primarily the planar alignment of a gas diffusion layer 11 that is to be tested. The dead weight 19 is arranged radially at least 15 mm outside of the vertically guided upper pressure plate 5 and does not influence the thickness measurement. When the upper pressure plate 5 is being lowered via the test weight 9, an introduced gas diffusion layer 11 can thus be pressed flatly onto the support under the force of the weight of the dead weight. The dead weight 19 is additionally prevented from rotating about the vertical axis and can be arrested and also detached in the upper position as and when required.

FIG. 5 shows a view of a measuring device 1 with a gas diffusion layer 11 inserted into the measuring device 1 before the start of the measurement. In this case, the test weight 9 and thus the upper pressure plate 5 are in a vertically upper position. The gas diffusion layer 11 is a splayed sheet-like component 10 and may have a manufacturing-related curvature, primarily at the edges. This is indicated in FIG. 5. The dead weight 19 has been introduced in the form of an additional weight into the measuring device and arranged radially and concentrically around the periphery of the upper pressure plate 5 at a distance therefrom. The dead weight 19 may be in the form of a solid metallic hollow cylinder, a circular and planar support surface being provided for the function of the dead weight 19. Therefore, the inside diameter A of the dead weight 19 is greater than the diameter D of the upper pressure plate 5 and of the lower pressure plate 3. The outside diameter B is correspondingly greater than the inside diameter A. Owing to the circular design, an adjusted active surface is provided by the dead weight 19. The lower pressure plate 3 is in the form of part of a lower punch 41 and is configured to have the effect of defined pressing of a surface during the measurement. In this case, the lower punch 41 is integrated in the tabletop 21, the circular lower pressure plate 3 being raised in relation to the solid tabletop 21. Correspondingly, the lower punch 41 has a similarly raised circular support surface which is congruent with the circular active surface of the dead weight 19. The upper pressure plate 5 is connected to the test weight 9 via a ball joint 43. The ball joint 43 makes it possible to precisely set and align, in plane-parallel fashion, the component contact surfaces 23 of the upper pressure plate 5 and of the lower pressure plate 3.

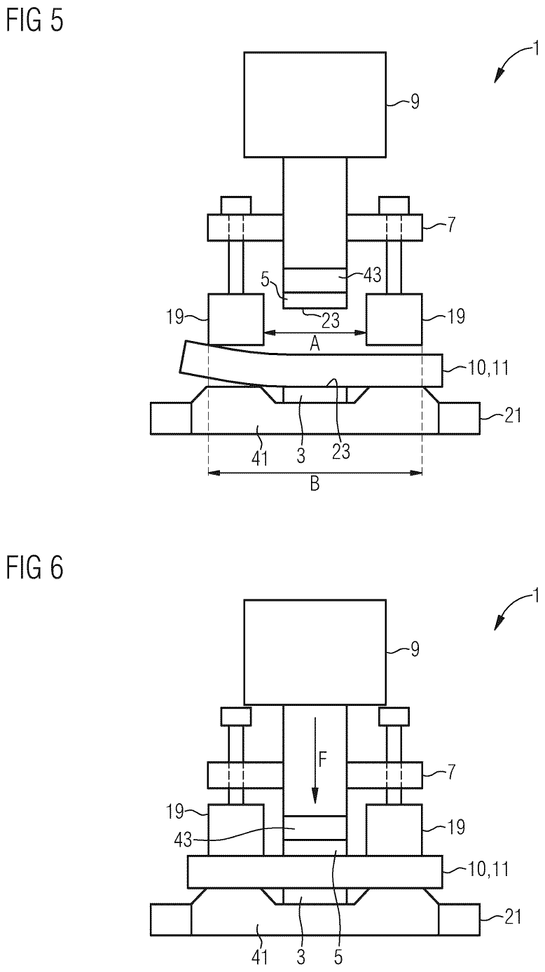

In comparison to FIG. 5, FIG. 6 shows the measuring device 1 during the thickness measurement on an introduced gas diffusion layer 11, a predefined pressing force F being introduced via the upper pressure plate 5 owing to the force of the weight of the test weight. The test weight 9 with the upper pressure plate 5 is lowered so that the testing force F brings about a defined local pressing of the surface of the gas diffusion layer 11. Furthermore, the dead weight 19 is correspondingly lowered and rests on the periphery in an accurate fit with the facing circular raised support surface of the lower punch 41. The effect of this is a very precise and reproducible planar alignment of the gas diffusion layer 11 for the measurement, specifically completely decoupled from the testing force F introduced via the test weight 9. The measurement can thus be carried out very precisely and at the same time easily, since the testing force F is particularly straightforwardly provided in the form of the force of the weight of the solid test weight 9, which is subject to virtually no or only very small tolerances. Owing to the simplicity of the measuring device 1 and the measuring method, no complex compensations are required, as was the case with the previously known universal testing machines for these measuring purposes.

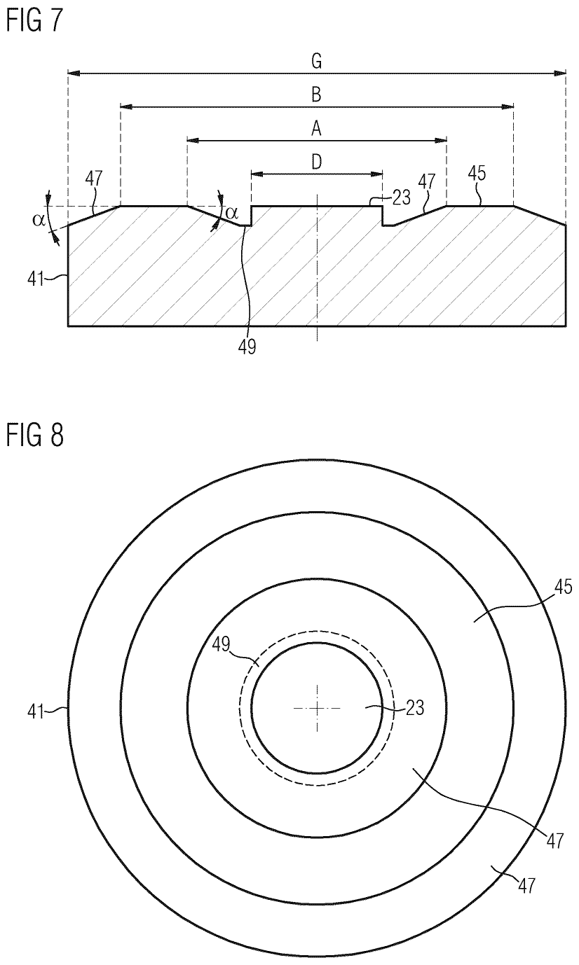

FIG. 7 shows a sectional view of a lower punch 41 with a lower pressure plate 3 and FIG. 8 shows a corresponding plan view of the lower punch 41 according to FIG. 7. The lower pressure plate 3 is an integral constituent part of the lower punch 41. The lower pressure plate 3 is cylindrical and has a circular component contact surface 23 of predefined diameter D, for example D=50 mm. The component contact surface 23 is flat and has been surface-treated, for example polished, and has a low mean roughness depth of Rz<4. The overall diameter G of the lower punch 41 can typically be G=190 mm. The inside diameter A can be for example A=110 mm and the outside diameter B can be for example B=140 mm. This results in the formation of a likewise raised circular annular surface 45 which is in the form of a contact surface and concentrically encloses the component contact surface 23 at a radial distance therefrom. The lower punch 41 is designed in one piece and made of solid stainless steel, preferably in the form of a turned part and surface-treated. The transition from the raised annular surface 45 in the radially inward direction to the raised component contact surface 23 and in the radially outward direction to the edge of the lower punch 41 is in the form of a slope 47 with an angle a of typically α=20° for the slope 47. This provides a concentric recess around the lower pressure plate 3 that advantageously makes it easier to insert and position the gas diffusion layer 11 for a measurement. In this recess around the lower pressure plate 3, a planar transition region radially inwardly adjoins the slope 47.

FIG. 9 shows a schematic plan view of a measuring table 27. It provides a measuring system for measuring the thickness of a gas diffusion layer 11. The measuring table 27 has a solid tabletop 21 and incorporates the measuring device 1 described above. Corresponding to the number of measurement points 25, a corresponding number of lower punches 41 each with a lower pressure plate 3 is integrated in the tabletop 21; cf. correspondingly FIG. 7 and FIG. 8. The measurement points 25 are in the form of a grid and arranged uniformly on the tabletop 21. Variable stops 49 allow and make possible an accurately fitting and flexible setting of a desired location and positioning of the gas diffusion layer 11. Corresponding to the number and arrangement of the measurement points 25 on the measuring table, each of the measurement points 25 is assigned a dedicated cantilever arm 39 in the form of a C-profile with a respective lifting mechanism 15. To lift and lower the test weights 9 during a measurement sequence, a guide unit 53 which can be activated for example via a cable pull system is attached to the cantilever arm 39. To protect the operator 55, a safety device 51 which has for example a light curtain is provided. Furthermore, a control unit with a control panel 29 is provided, so that the measuring process can be controlled and monitored automatically. In this case, measured data from the distance sensor 13 or from the calibration device 17 are read into a processor and processed. For automatic feeding, a transporting unit—not represented in more detail—may be provided. To control and monitor the process, a central computer with an operating unit is advantageous. At the operating station, the results are displayed on the control panel 29 and stored. A measurement can be initiated by the operator 55, for example via a foot switch. At the same time, a service function with a manual mode as and when required is implemented for the measuring table 27, this manual mode involving the operator coming up to the lower end position of the test weights 9, for example in order to adjust the ball joint 43.

In the case of a measuring operation for measuring the thickness of a gas diffusion layer 11, a measuring device 1 is provided, and in the measuring operation: a gas diffusion layer 11 is inserted into the measuring device 1 in the form of a sheet-like component 10; during a measuring operation, a predefinable testing force F is applied to the gas diffusion layer via the force of the weight of the test weight 9 by lowering the test weight 9 so that a defined surface pressure is exerted; and the distance between the upper pressure plate 5 and the lower pressure plate 3 under the predefinable testing force F is determined. A current reference value is ascertained as the respective zero point and thereby the distance between the upper pressure plate 5 and the lower pressure plate 3 is calibrated. In a measuring operation, a thickness is measured simultaneously at multiple measuring points 25 distributed over the surface of the gas diffusion layer 11.

1. A measuring device for measuring a thickness of a gas diffusion layer for an electrochemical cell, comprising:
a lower pressure plate;
an upper pressure plate and a test weight guided via a vertical guide in such a way that, during a measuring operation, a predefinable testing force can be applied via the force of the weight of the test weight to a sheet-like component that is to be tested, so that a defined surface pressure is exerted; and
a distance sensor which makes it possible to determine, as measured thickness value (H), the distance taken up by the sheet-like component between the upper pressure plate and the lower pressure plate under the predefinable testing force (F).

2. The measuring device as claimed in claim 1, comprising a lifting mechanism (15) by means of which the test weight can be lowered and as a result the predefinable testing force (F) can be applied to the sheet-like component via the force of the weight.

3. The measuring device as claimed in claim 2, wherein the lifting mechanism (15) is configured such that, during a measuring operation, the test weight undergoes a decoupling, with the result that no additional force is applied to the sheet-like component beyond the testing force (F) imparted by the test weight.

4. The measuring device as claimed in claim 1, wherein the force of the weight of the test weight can be set, thereby making it possible to calibrate the testing force (F).

5. The measuring device as claimed in claim 1, wherein the vertical guide is prevented from rotating about a vertical axis, thereby ensuring a positionally accurate and reproducible lowering of the test weight.

6. The measuring device as claimed in claim 1, wherein provision is made of a calibration device for ascertaining a current reference value as a zero point of a distance measurement and thereby calibrating the distance between the upper pressure plate and the lower pressure plate.

7. The measuring device as claimed in claim 1, wherein provision is made of a dead weight arranged radially on an outside of the upper pressure plate so that, when the upper pressure plate is being lowered, a sheet-like component that is to be tested can be pressed flat onto a support under the force of the weight of the dead weight.

8. The measuring device as claimed in claim 7, wherein the dead weight is prevented from rotating about a vertical axis, and the dead weight can be arrested and detached as and when required.

9. The measuring device as claimed in claim 1, wherein the pressure plates are both designed as planar circular plates, which are made of a hardened corrosion-resistant steel and are aligned congruently and in plane-parallel fashion relative to one another.

10. The measuring device as claimed in claim 1, wherein the upper pressure plate is connected to a shaft of the test weight via a ball joint, such that a plane-parallel alignment of the pressing surfaces of the upper pressure plate and of the lower pressure plate can be set.

11. A measuring device which has a plurality of plate pairs each comprising an upper pressure plate and a lower pressure plate, the plate pairs being arranged such that, during a measurement, respective measured thickness values (H) of a sheet-like component introduced for a measurement can be ascertained at multiple measurement points simultaneously.

12. The measuring device as claimed in claim 11, wherein the plate pairs are arranged uniformly, making it possible to determine respective local measured thickness values (H) of a sheet-like component introduced for a measurement.

13. A measuring table comprising a measuring device as claimed in claim 1, comprising a tabletop in which a lower pressure plate is integrated, with a support surface for receiving a sheet-like component of which the thickness is to be measured being formed on the tabletop.

14. The measuring table as claimed in claim 13, comprising a control unit which has a control panel, so that a measuring process can be controlled and monitored, and measured data from the distance sensor can be read into a processor and processed.

15. The measuring table as claimed in claim 13, comprising a transporting unit for loading and unloading a sheet-like component.

16. A method for measuring a thickness of a gas diffusion layer of an electrochemical cell, the method comprising:
inserting a gas diffusion layer is inserted into a measuring device in a form of a sheet-like component;
applying, during a measuring operation, a predefinable testing force (F) to the gas diffusion layer via the force of a weight of a test weight by lowering the test weight so that a defined surface pressure is exerted; and
measuring a distance between an upper pressure plate and the lower pressure plate under the predefinable testing force (F).

17. The method as claimed in claim 16, wherein a current reference value is ascertained as the respective zero point and thereby the distance between the upper pressure plate and the lower pressure plate is calibrated.

18. The method as claimed in claim 16, wherein, during a measuring operation, the thickness is simultaneously measured at multiple measurement points distributed over the surface of the gas diffusion layer.
